(19) United States
(12) Patent Application Publication
(10) Pub. No.: US 2024/0262382 A1
(43) Pub. Date: Aug. 8, 2024

(54) MULTI-OBJECT TRACKING WITH DATA SOURCE PRIORITIZATION

(71) Applicant: TOYOTA MOTOR ENGINEERING & MANUFACTURING NORTH AMERICA, INC., Plano, TX (US)

(72) Inventors: XIAOFEI CAO, Mountain View, CA (US); EMRAH AKIN SISBOT, Mountain View, CA (US); YASHAR ZEIYNALI FARID, Mountain View, CA (US); HARITHA MURALIDHARAN, Mountain View, CA (US); KENTARO OGUCHI, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/165,875

(22) Filed: Feb. 7, 2023

(51) Int. Cl. B60W 60/00; B60W 40/04; G01C 21/00

(52) U.S. Cl. CPC B60W 60/001; B60W 40/04; G01C 21/3807; G01C 21/3885; B60W 2554/404; B60W 2554/80; B60W 2556/45

(57) ABSTRACT

Systems and methods are provided for multi-object tracking, for example by vehicles, with data source prioritization. Some embodiments of the present disclosure are directed to multi-vehicle, multi-object tracking and prioritization based on vehicle or sensor capabilities or accuracy levels.

### TECHNICAL FIELD

The present disclosure relates generally to systems and methods for multi-object tracking with data source prioritization. More particularly, some embodiments relate to multi-vehicle, multi-object tracking and data source prioritization based on vehicle or sensor capabilities.

### DESCRIPTION OF RELATED ART

Vehicles, including both autonomous and non-autonomous vehicles, are often equipped with systems that collect sensor data and transmit the sensor data to a server. Vehicles are also often equipped with vehicle navigation systems that typically receive traffic information indicating the amount of traffic that is on a particular road or road segment, and display that information to a human driver or use the information to control the driving of an autonomous vehicle.

### BRIEF SUMMARY OF THE DISCLOSURE

According to various embodiments of the disclosed technology, systems and methods for multi-object tracking, for example by vehicles, with data source prioritization are provided. Some embodiments of the present disclosure are directed to multi-vehicle, multi-object tracking and prioritization based on vehicle or sensor capabilities or accuracy levels. Some embodiments of the present disclosure utilize multiple algorithmic and functional technical solutions to improve upon multi-object, multi-view tracking.

In accordance with some embodiments, a system implemented in an edge/cloud server for tracking multiple objects detected by connected vehicles comprises a memory storing instructions, and one or more processors communicably coupled to the memory and configured to execute the instructions to receive a plurality of local tracklets. Each local tracklet, which is received from a respective connected vehicle, comprises sensor data corresponding to a respective object that may be detected at lane level within a respective time period using one or more sensors communicating with the respective connected vehicle. Each local tracklet has a local ID assigned by the respective connected vehicle.

The system associates a respective local tracklet with a corresponding existing global tracklet when there is a match between (1) the local ID of the respective local tracklet and a global ID of the corresponding existing global tracklet, or (2) a position/direction of an object identified by the respective local tracklet and a position/direction of an object identified by the corresponding existing global tracklet. When there is no match, a new global tracklet is created, and the unmatched local tracklet is associated with the corresponding new global tracklet.

The system assigns a priority score to each received local tracklet based on (1) the accuracy of the one or more sensors that detected the respective object and (2) the distance from the one or more sensors to the respective object. The system updates each respective global tracklet with (1) all received local tracklets associated with the respective global tracklet within the same time period, (2) the priority score assigned to each associated local tracklet, and (3) a weighted average location of the associated local tracklets based on the priority score assigned to each associated local tracklet. The system reduces global tracklet candidates using the cosine distance of their history trajectory to remove redundant global tracklet candidates, and constructs a global traffic map at a lane level from the updated global tracklets.

In some example embodiments, each object corresponds to an observed vehicle. Each local tracklet may include identifying data comprising location, velocity, yaw, yaw rate, and acceleration of the respective object. In example embodiments the position/direction of an object identified by the respective local tracklet, and the position/direction of an object identified by a corresponding existing global tracklet, are determined based on Intersection Over Union (IOU) values of each pair of unassociated local and global tracklets and their Mahalanobis distance, and a Linear Assignment Problem (LAP) Solver is used to determine the match.

The system may transmit the global tracklets or a global tracklet map to one or more connected vehicles. The system may transmit a control signal to an autonomous connected vehicle based on the global tracklets or global traffic map, to control a route of the autonomous connected vehicle at lane level. The system may transmit a signal to a connected vehicle to update an online navigation system of the connected vehicle based on the global tracklets or global traffic map. The system may store a history of each global tracklet, and construct a trajectory of each global tracklet based on the history.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for multi-object tracking in accordance with one embodiment of the systems and methods described herein.

FIG. 3 is an example network architecture of a global tracklet system in accordance with various embodiments disclosed herein.

FIG. 4 is a schematic diagram illustrating a method performed by a global tracklet system according to one example embodiment.

FIG. 5 illustrates a method for creating local tracklets according to an example embodiment.

FIG. 6 is an example computing component that may be used to implement various features of embodiments described in the present disclosure.

The figures are not exhaustive and do not limit the present disclosure to the precise form disclosed.

### DETAILED DESCRIPTION

The present disclosure, in example embodiments, is directed to systems and methods for creating a global traffic map based on sensor data received from connected vehicles, the global traffic map including lane-level traffic data. At a high level, connected vehicles observe their surroundings and detect and track objects, such as other vehicles, using sensors. The connected vehicles transmit the sensor data pertaining to respective objects to a cloud server. The cloud server receives the sensor data from the connected vehicles and merges the detected objects into a global traffic map.

Autonomous driving vehicles, vehicle navigation systems, and other vehicle systems often benefit from having traffic information. Road level traffic information generally refers to the amount of traffic that is on a particular road or road segment. There are existing systems for providing assessments related to road level traffic information, or that use road level traffic information for various applications such as navigation. However, navigation using only road level traffic information can be accurate only up to a point. For example, some lanes can be congested when others are free. Navigation based only on road level traffic information cannot provide instructions to autonomous vehicles, or recommendations to human drivers, with lane-level accuracy. Yet autonomous/automated driving requires, in addition to road level traffic information, lane level traffic information.

Lane-level traffic information generally refers to the amount of traffic that is in each lane or a particular lane of a road. Road level traffic information may not provide as much information as lane level traffic information. As one lane of a road may have significantly more traffic than another lane of a road, information as to which lanes are less congested and which are more congested would be useful for a driver to learn from the navigation system and can increase the accuracy and utility of the navigation system. Smartphones fail to generate lane-level traffic information due for example to errors in GPS positioning. Smartphones also are typically not equipped with various sensors that vehicles may be equipped with or connected to. Moreover, not all vehicles have smartphones inside.

Moreover, typical tracking/merging approaches are done without considering prioritization, e.g., without considering the reliability of the sensor or sensors used to detect an object. In contrast, one notable aspect of the present disclosure is data source prioritization. Some detected objects have a higher priority due to better sensors located on higher end vehicles, or due to a closer distance between the sensor and the detected object, for example. Accordingly, higher priority can be used in the present disclosure to determine congested or blocked lanes, etc.

Technical solutions are realized throughout the present disclosure. Embodiments of the present disclosure can improve the accuracy of a system that uses only road-level traffic information, by also using lane-level traffic information. In example embodiments the system is a navigation system that uses both road level traffic information and lane level traffic information. The system can provide control signals or instructions to autonomous vehicles, or recommendations/suggestions to human drivers, that factor in lane-level traffic information to allow for vehicle control or navigation on a per-lane basis.

Example embodiments of the disclosed technology are directed to a cloud system that gathers vehicle detection results from respective connected vehicles, prioritizes the detection results based on the capabilities of the source vehicles, and combines or aggregates the data to create a single lane-level traffic view. A traffic view showing respective single lanes of the road and the level of traffic in respective single lanes can be displayed by the GPS or navigation system. Connected vehicles or ego vehicles act as observers and have the ability to send the observed vehicle's location and lane information (in which lane from the left/right side of the road). The edge/cloud server can decide the exact lane level information based on the map.

In more detail, in example embodiments of the present disclosure an edge/cloud server (1) receives sensor data comprising vehicle detection data from a plurality of connected vehicles, (2) prioritizes the sensor data based on the sensor capabilities of each connected vehicle, and (3) combines or aggregates the sensor data to create a single lane-level traffic view and/or provide control signals to an autonomous vehicle to control navigation of the autonomous vehicle on a lane by lane basis. In examples, a plurality of connected vehicles each gather data associated with traffic around the vehicle using a variety of sensors (e.g., camera, Radar, Lidar, GPS, etc.). This data can be used to accurately estimate traffic mobility. As each connected vehicle gathers sensor data, the sensor data is transmitted to a cloud server. Accordingly, each connected vehicle can constantly or continuously share its observed local traffic information to the cloud, anonymously and preferably in real-time or near real-time.

Because different connected vehicles have different sensing capabilities (some vehicle models with better/more sensors, some with worse/less sensors), the data received from each connected vehicle is given a respective priority score based on (a) the accuracy of the sensors of a connected vehicle and/or (b) the distance between the connected vehicle and other vehicles or objects observed by the sensor data. With respect to the distance between the connected vehicle and other observed vehicles/objects, accuracy tends to improve as distance decreases. Accordingly, each observation from a respective connected vehicle is scored with a priority score. The cloud server merges the data from the connected vehicles, factoring in the priority scores, into a global traffic map.

In still more detail, sensor data obtained from one or more sensors within a specified time period is composed into respective local tracklets by respective connected vehicles, each local tracklet corresponding to a respective object. An object may be another vehicle such as a car, a truck, a motorcycle, etc. Each local tracklet corresponds to the time period or time interval that the sensor data was created in.

At least one sensor is equipped to detect lane-level traffic data. The local tracklets are sent by the connected vehicles to a cloud server. The cloud server attempts to associate each local tracklet with a corresponding global tracklet. There are various methods described herein for associating or “matching” a local tracklet with a corresponding global tracklet. If a corresponding global tracklet does not exist, or a local tracklet cannot be matched with an existing corresponding global tracklet, the local tracklet is associated with a new global tracklet.

The cloud server assigns a priority score to each local tracklet based on reliability of the particular sensor data used to create the local tracklet (e.g., based on sensor accuracy and distance from the sensor to the observed object). The cloud server then carries out a merging procedure, in which the cloud server updates each respective global tracklet with (1) all received local tracklets associated with the respective global tracklet, and (2) the priority score assigned to each local tracklet. Each global tracklet is then filtered by dropping associated local tracklets having lower priority scores, to produce updated and filtererd global tracklets.

The global tracklets can be used in a variety of applications. Some example embodiments utilize the global tracklets to create and display in a connected vehicle a global traffic map that includes lane-by-lane traffic information. Routes and open lanes can be suggested based on the traffic information. Some example embodiments utilize the global tracklets to control an autonomous vehicle based on the global traffic map. Accordingly, local observations (as prioritized tracklets corresponding to respective objects or observed vehicles) can thus be merged into a unique global traffic map in the cloud. Of course, these are just example embodiments and the present disclosure is not limited thereto.

With further regard to the process of associating respective local tracklets with corresponding global tracklets, in an example embodiment each local tracklet is assigned, by the respective connected vehicle, a fixed local ID that corresponds to the observed object. As the cloud server receives local tracklets from respective connected vehicles, the cloud server attempts to associate the local tracklets with corresponding global tracklets based on matching the local ID of the local tracklet with a global ID of a respective global tracklet already in existence. This can be performed for example by checking the local ID against a table of global IDs, each global ID in the table corresponding to a respective global tracklet.

If a local tracklet cannot be associated with an existing global tracklet on the basis of ID matching, the cloud server then attempts to associate the local tracklet with an existing global tracklet on the basis of the position/direction of the object identified by the local tracklet and the position/direction of an object identified by the existing global tracklet. If the local tracklet still cannot be associated with an existing global tracklet then a new global tracklet is created and the local tracklet is associated with the new global tracklet.

Each global tracklet associates with one or more local tracklets, and typically with multiple local tracklets. Both local and global tracklets have a list of features or data including but not limited to lane information, vehicle type, and size. A pair of associated local and global tracklets correspond to the same time period that the object data was detected in.

As used herein, the words “geographic location,” “location,” “geographic position” and “position” refer to a latitude and longitude of an object (or, a latitude, longitude, and elevation of an object), such as a vehicle, etc. As used herein, the words “geographic area”, “area,” and “region” refer to a physical space surrounding a geographic location and/or object (e.g., an area of defined space surrounding a geographic location or position).

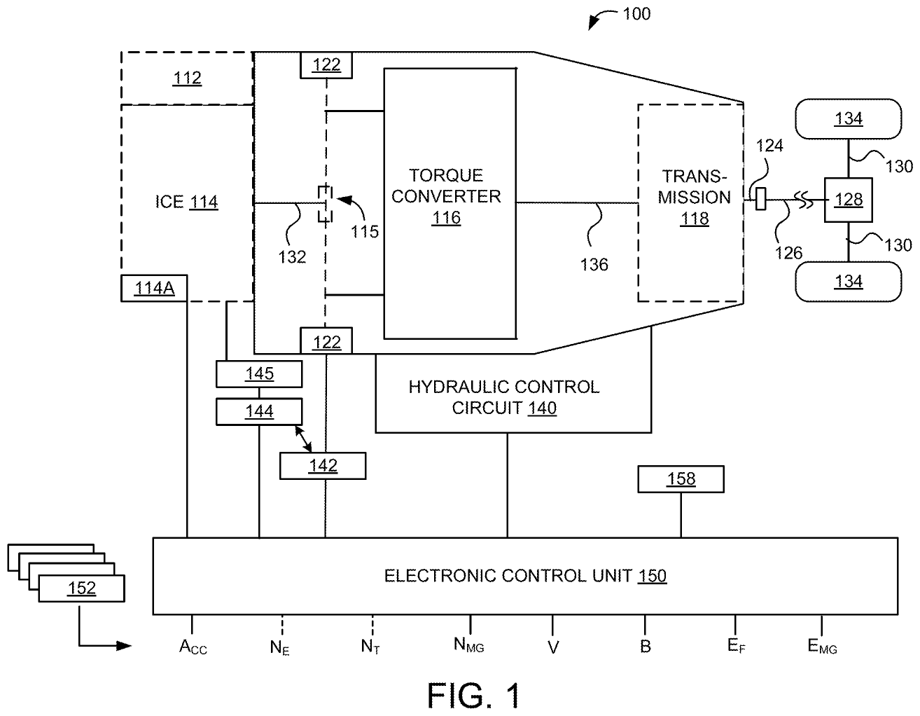

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for multi-object tracking with data source prioritization described in embodiments herein can be implemented in other types of vehicles including electric vehicles, internal combustion engine vehicles, autonomous vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit 140. When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 114 (engine RPM), a rotational speed, NMG, of the motor 122 (motor rotational speed), and vehicle speed, NV. These may also include torque converter 116 output, NT (e.g., output amps indicative of motor output), brake operation amount/pressure, B, or battery SOC (i.e., the charged amount for battery 144 detected by an SOC sensor).

Electronic control unit 150 may also receive, from one or more sensors 152 included in vehicle 100 or external to vehicle 100, signals that indicate or detect objects external to the vehicle 100, such as other vehicles in the roadway and typically in a particular lane of the roadway. These signals can include information including but not limited to a location, velocity, yaw, yaw rate, and acceleration of another object or vehicle detected by sensors of vehicle 100 or by other connected vehicles.

Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). In one embodiment, sensors 152 may be included to detect one or more conditions directly or indirectly such as, for example, fuel efficiency, EF, motor efficiency, EMG, hybrid (internal combustion engine 114+MG 112) efficiency, acceleration, ACC, etc.

In some embodiments, one or more of the sensors 152 may include their own processing capability to compute the results for additional information that can be provided to electronic control unit 150. In other embodiments, one or more sensors 152 may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

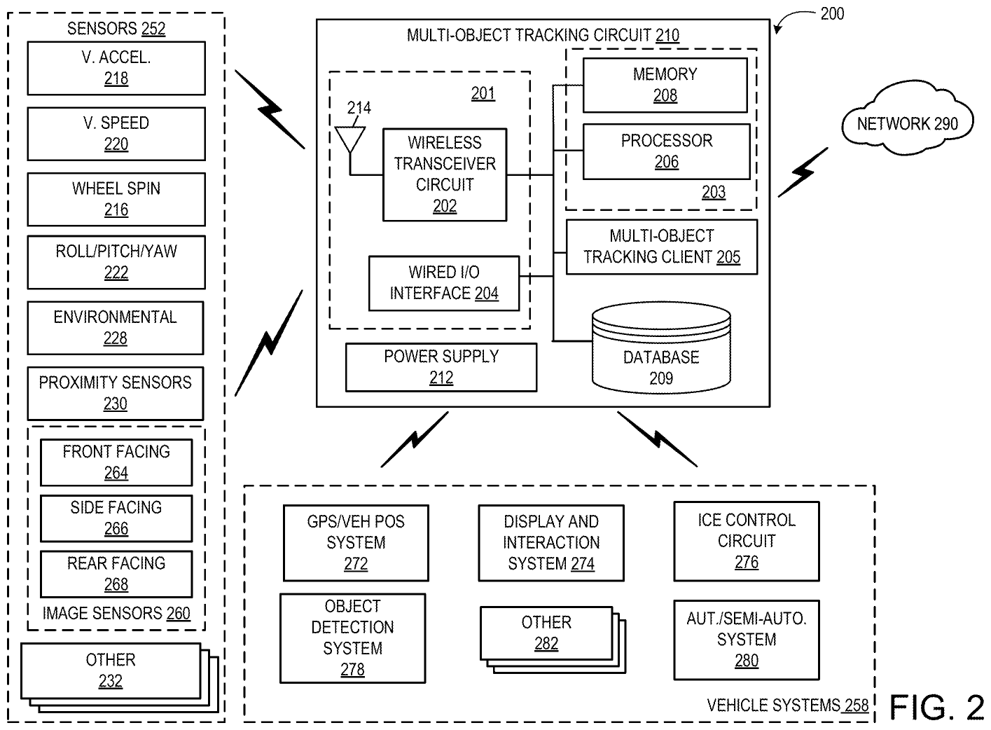

FIG. 2 illustrates an example architecture for multi-object tracking with data source prioritization in accordance with one embodiment of the systems and methods described herein. Referring now to FIG. 2, in this example, multi-object tracking system 200 includes a multi-object tracking circuit 210, a plurality of sensors 252, and a plurality of vehicle systems 258. The multi-object tracking system 200 can also be referred to as a local tracklet system or a system for creating local tracklets.

Sensors 252 (such as sensors 152 described in connection with FIG. 1) and vehicle systems 258 (such as systems 158 described in connection with FIG. 1) can communicate with multi-object tracking circuit 210 via a wired or wireless communication interface. Although sensors 252 and vehicle systems 258 are depicted as communicating with multi-object tracking circuit 210, they can also communicate with each other, as well as with other vehicle systems. Multi-object tracking circuit 210 can be implemented as an ECU or as part of an ECU such as, for example electronic control unit 150. In other embodiments, multi-object tracking circuit 210 can be implemented independently of the ECU.

Multi-object tracking circuit 210 in this example embodiment includes a communication circuit 201, a decision circuit 203 (including a processor 206 and memory 208 in this example) and a power supply 212. Components of multi-object tracking circuit 210 are illustrated as communicating with each other via a data bus, although other communication interfaces can be included. Multi-object tracking circuit 210 in this example also includes multi-object tracking client 205.

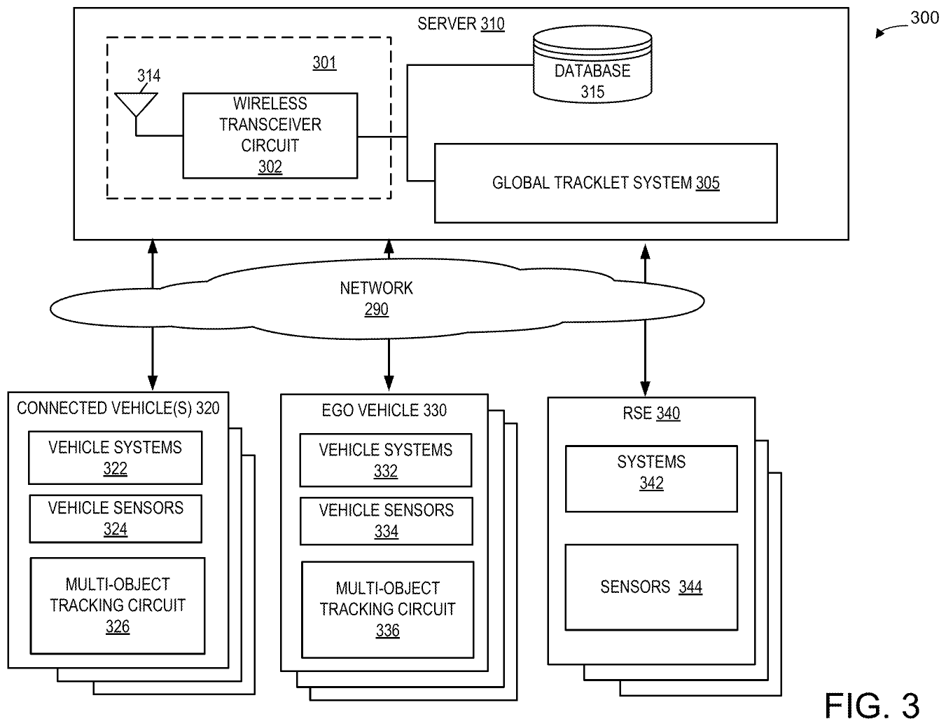

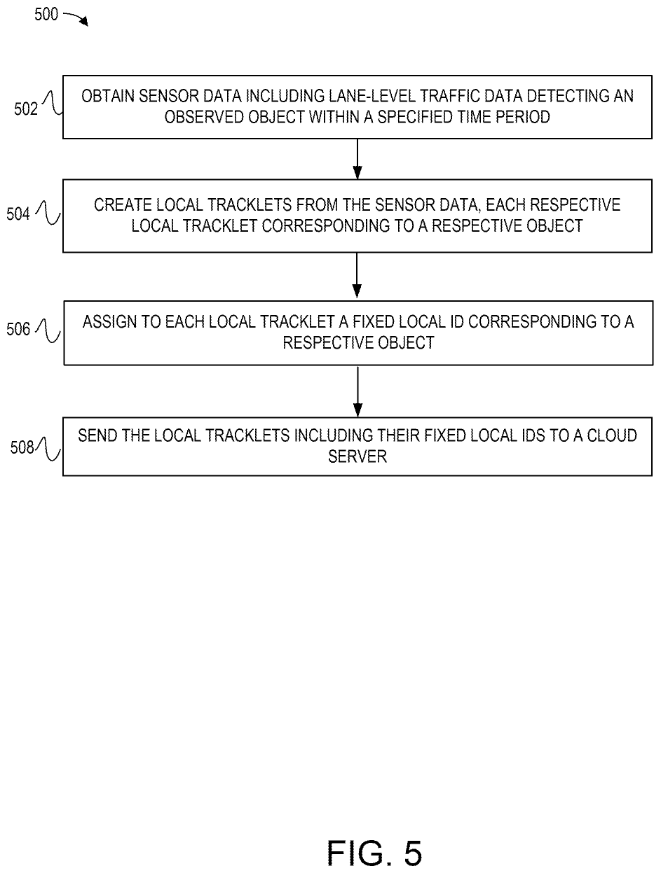

FIG. 5 illustrates a method 500 for creating local tracklets according to an example embodiment. The method 500 may be performed, for example, by multi-object tracking system 200 of FIG. 2, and more particularly by multi-object tracking circuit 210 and multi-object tracking client 205. The vehicle may be an electric or hybrid electric vehicle such as, for example, vehicle 100 of FIG. 1, connected vehicle 320 of FIG. 3, or ego vehicle 330 of FIG. 3. The vehicle 100 may be other types as well including but not limited to an internal combustion engine vehicle. The vehicle 100 may be an autonomous or a non-autonomous vehicle.

At operation 502 sensor data is received or obtained from sensors connected to or communicating with the vehicle 100, such as from sensors 152. The sensor data may detect objects such as other vehicles and may include lane-level traffic data and/or road-level traffic data. The sensor data can be stored in database 209 which is accessible by multi-object tracking client 205. Accordingly, the multi-object tracking client 205 can be operated to, among other actions, receive or access sensor data detecting one or more objects.

At operation 504 the multi-object tracking client 205 uses the sensor data to create local tracklets. More specifically, the multi-object tracking client 205 can use input data from sensors 152, 252, and/or from vehicle systems 258 or from other internal or external sensors or systems, to create local tracklets.

In still more detail, at operation 504 the multi-object tracking client 205 composes sensor data obtained from one or more sensors within a specified time period into local tracklets, each respective local tracklet corresponding to a respective object such as an observed vehicle. A local tracklet is, in one aspect, a time stamp of when the data was sensed. A local tracklet includes other information as well, as described herein.

At operation 506 the multi-object tracking client 205 assigns each local tracklet a fixed local ID that corresponds to the observed object or vehicle. This is one way that the multi-object tracking client 205 tracks an observed object. The multi-object tracking client 205 can thereby follow the location/velocity/acceleration of an observed object for a certain amount of time. Each vehicle 100 assigns its own fixed local IDs in this manner without communicating with other connected vehicles 320.

The local tracklets can be stored in a non-linear filter (constant turn-rate and acceleration filter) which includes data such as location/position, velocity, yaw and yaw rate, and acceleration/direction, etc., of the observed object. Such a data structure can store all relevant data pertaining to the observed object.

At operation 508 the multi-object tracking circuit 210 sends the local tracklets including their fixed local IDs and other relevant information to an edge/cloud server such as edge/cloud server 310 of FIG. 3. Accordingly, sensor data such as vehicle detection data is sent from the multi-object tracking circuit 210 of the connected vehicle 100 to an edge/cloud server 310.

In example embodiments, a plurality of connected vehicles 100 each gather data associated with traffic around the vehicle using a variety of sensors (e.g., camera, Radar, Lidar, GPS, etc.). This data can then be used by the edge/cloud server 310 to accurately estimate traffic mobility. As each connected vehicle 320 gathers sensor data, the sensor data is transmitted to the edge/cloud server 310. Accordingly, each connected vehicle 320 can constantly or continuously share its observed local traffic information to a cloud server, anonymously and preferably in real-time or near real-time.

Different connected vehicles 320 have different sensing capabilities; i.e., some vehicles have better/more sensors while other vehicles have worse/less. The sensor data obtained by each connected vehicle 100 and sent to the edge/cloud server 310 includes information pertaining to the type, capabilities, conditions, or accuracy of the sensors 152, 252 that detected a respective object, so that the edge/cloud server 310 can create a priority score of each detected object based on sensor accuracy and/or distance from the sensor to the detected object. (In alternate embodiments, the multi-object tracking client 205 itself can calculate/assign a priority score of each detected object and send this information to the edge/cloud server 310.)

Thus, each connected vehicle 320 creates a respective local tracklet based on collected sensor data. Each local tracklet corresponds to a respective object such as an observed vehicle. Each local tracklet is assigned by the connected vehicle 320 a fixed local ID that corresponds to the observed object or vehicle. A local tracklet can indicate information such as a location, velocity, yaw, yaw rate, and acceleration of another object or vehicle detected by the vehicle sensors 152, 252. Each local tracklet is sent to an edge/cloud server 310. The local tracklet can include information as to the sensor type and the distance from the sensor or sensors to the observed object. Ultimately, the local tracklet is assigned a priority score (either by the edge/cloud server 310 or by the multi-object tracking client 205) based on the reliability of the particular sensor data used to create the local tracklet (e.g., based on sensor accuracy and/or distance to the observed object). Each local tracklet corresponds to the time period or time interval that the sensor data was created in.

The multi-object tracking client 205 can also communicate with the edge/cloud server 310 via communication circuit 201 over the network 290 to perform, among other actions, one or more of the following: (a) send local tracklets and sensor information to the edge/cloud server 310, (b) receive global tracklets created by the edge/cloud server 310, (c) receive and display, e.g., by an onboard GPS or navigation system, a global traffic map, comprised of global tracklets, that includes lane-by-lane traffic information or a single lane-level traffic view, (d) receive, if the vehicle 100 is an autonomous vehicle, control signals from the edge/cloud server 310 based on the global tracklets or global traffic map to control the vehicle 100 on a per-lane basis based on the global traffic map, or (e) receive, in a GPS or onboard navigation system, data relating to suggestions or instructions from the edge/cloud server 310 regarding suggested routes for a driver based on the global tracklets or global traffic map that factor in lane-level traffic information along with road-level traffic information. These can be displayed to the driver via a vehicle dashboard system display and/or speaker of interaction system 274 or delivered to the driver in another way. Other actions can be performed as well. Data or information received from the edge/cloud server 310 can be stored in the database 209.

Returning to FIG. 2, processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as data relating to driving style, preferences, or common driving locations/times of a particular driver along with other data as needed. Memory 208 can be made up of one or more modules of one or more different types of memory, and may be configured to store data and other information as well as operational instructions that may be used by the processor 206 to multi-object tracking circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a multi-object tracking circuit 210.

Communication circuit 201 includes either or both of a wireless transceiver circuit 202 with an associated antenna 214 and a wired I/O interface 204 with an associated hardwired data port (not illustrated). Communication circuit 201 can provide for V2X and/or V2V communications capabilities, allowing multi-object tracking circuit 210 to communicate with edge devices, such as roadside unit/equipment (RSU/RSE), network cloud servers and cloud-based databases, and/or other vehicles via network 290. For example, V2X communication capabilities allows multi-object tracking circuit 210 to communicate with edge/cloud devices, roadside infrastructure (e.g., such as roadside equipment/roadside unit, which may be a vehicle-to-infrastructure (V2I)-enabled street light or cameras, for example), etc. Multi-object tracking circuit 210 may also communicate with other connected vehicles over vehicle-to-vehicle (V2V) communications.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with multi-object tracking circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by multi-object tracking circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the multi-object tracking system 200 is implemented. The sensors 252 may be included in vehicle 100 or external to vehicle 100, and may provide signals that indicate or detect objects external to the vehicle 100, such as other vehicles. These signals can include information such as a location, velocity, yaw, yaw rate, and acceleration of another object or vehicle detected by sensors of vehicle 100 or by other connected vehicles. In the illustrated example, sensors 252 include vehicle acceleration sensors 218, vehicle speed sensors 220, wheelspin sensors 216 (e.g., one for each wheel), accelerometers such as a 2-axis accelerometer 222 to detect roll, pitch and yaw of the vehicle, environmental sensors 228 (e.g., to detect salinity or other environmental conditions), and proximity sensor 230 (e.g., sonar, radar, lidar or other vehicle proximity sensors). Additional sensors 232 can also be included as may be appropriate for a given implementation of multi-object tracking system 200. Additional sensors 232 may include one or more of: current state of charge (SOC); current location and destination (e.g., from an onboard navigation system); static route information (e.g., road type, slope, etc.); dynamic route information (e.g., traffic event, congestion, etc.); vehicle dynamics (e.g., gas, speed, etc.); vehicle states (e.g., HVAC setting, tire pressure, battery age, etc.); supplementary information (e.g., ambient temperature, etc.); distance from the sensor to an observed object; or others. Information as to the accuracy of various sensors 252 is available as well.

The information from the sensors 152, 232, or 252 may be accessible by multi-object tracking client 205 for creating local tracklets as described herein. The sensor data, and information pertaining to the sensors such as type, accuracy, etc. can be stored in database 209 and accessible by multi-object tracking client 205 for creating the local tracklets.

Multi-object tracking system 200 may be equipped with one or more image sensors 260. These may include front facing image sensors 264, side facing image sensors 266, and/or rear facing image sensors 268. Image sensors may capture information which may be used in detecting not only vehicle conditions but also detecting conditions or objects external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used, for example, to detect objects in an environment surrounding a vehicle comprising multi-object tracking system 200, for example, surrounding vehicles, roadway environment, road lanes, road curvature, obstacles, and so on. For example, a one or more image sensors 260 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 260 may include cameras that may be used with and/or integrated with other proximity sensors 230 such as LIDAR sensors or any other sensors capable of capturing a distance. As used herein, a sensor set of a vehicle may refer to sensors 252.

Vehicle systems 258, for example, systems and subsystems 258 described above with reference to the example of FIG. 2, can include any of a number of different vehicle components or subsystems used to control or monitor various aspects of the vehicle and its performance. In this example, the vehicle systems 258 includes a vehicle positioning system 272; engine control circuits 276 to control the operation of engine (e.g. internal combustion engine 114 and/or motors 122); object detection system 278 to perform image processing such as object recognition and detection on images from image sensors 260; proximity estimation, for example, from image sensors 260 and/or proximity sensors, etc. for use in other vehicle systems; vehicle display and interaction system 274 (e.g., vehicle audio system for broadcasting notifications over one or more vehicle speakers), vehicle display system and/or the vehicle dashboard system); and other vehicle systems 282 (e.g., Advanced Driver-Assistance Systems (ADAS), autonomous or semi-autonomous driving systems 280, such as forward/rear collision detection and warning systems, pedestrian detection systems, autonomous or semi-autonomous driving systems, and the like).

The vehicle positioning system 272 can include a conventional global positioning system (GPS) and/or a DRSC-compliant GPS (Dedicated Short-Range Communication), either which can be utilized by the multi-object tracking circuit 210 of the present disclosure. A vehicle 100 may for example be a DSRC-equipped vehicle (Dedicated Short-Range Communication). A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy. Both a conventional GPS and a DSRC-compliant GPS, or other types of GPS systems, may be used with the disclosed technology.

Returning to FIG. 2, network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

According to some embodiments, multi-object tracking client 205 includes code and routines that are operable, when executed by a processor 206, to cause the processor 206 to collect data captured from sensors 152, 232, 252 and/or vehicle system 258 (e.g., sensor data) and/or from other sources and process the sensor data to create the local tracklets. The sensor data, information regarding the sensors, the local tracklets, and other data/information, as well as data/information received from other connected vehicles 320 or from an edge/cloud server such as edge/cloud server 310, can be stored in database 209 and accessible by multi-object tracking client 205 or sent to edge/cloud server 310.

Communication circuit 201 can be used to transmit and receive information between multi-object tracking circuit 210 and sensors 252 (or, even if not specifically stated, 152 or 232), and between multi-object tracking circuit 210 and vehicle systems 258.

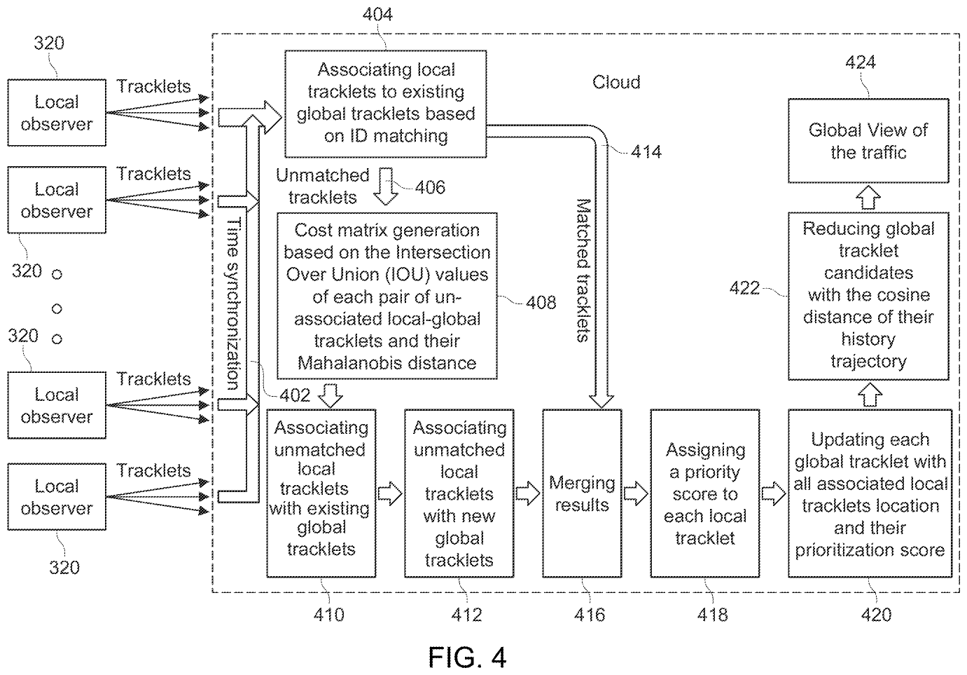

FIG. 3 is an example network architecture 300 of a global tracklet system in accordance with various embodiments disclosed herein. The architecture 300 includes a server 310 comprising a global tracklet system 305. The global tracklet system 305 in accordance with a non-limiting example embodiment is described in more detail below in connection with FIG. 4.

In FIG. 3 the server 310 communicates with one or more connected vehicles 320 (collectively referred to as connected vehicles or vehicle 320), an ego vehicle 330, and one or more roadside equipment (RSE) 340 (one RSE is shown for illustrative purposes only). The server 310, connected vehicle 320, ego vehicle 330, and RSE 340 can all communicate with one another in this example, directly or through network 290. For example, connected vehicles 320 can communicate with the ego vehicle 330, and the ego vehicle 330 and/or connected vehicles 320 can communicate with the RSE 340.

Server 310 may be an edge server, a cloud server, or a combination of the foregoing. For example, server 310 may be an edge server implemented as a processor-based computing device installed in an RSE (e.g., RSE 340 or the like) and/or some other processor-based infrastructure component of a roadway, and/or some other processor-based infrastructure component installed/implemented/located elsewhere. A cloud server may be one or more cloud-based instances of processor-based computing device residents on network 290. Server 310 in this example includes a communication circuit 301.

The global tracklet system 305 comprises code and routines that, when executed by a processor cause the processor to perform the operations and functions described herein. The global tracklet system 305 can communicate with a connected vehicle 320 via edge/cloud server 310 via communication circuit 201 over the network 290 to perform the actions described herein. The global tracking system 305 creates a global traffic map based on sensor data received from connected vehicles 320, in which the global traffic map includes lane-level traffic data and road-level traffic data.

As described above, each connected vehicle 320 obtains sensor data from one or more sensors within a specified time period, and composes the sensor data into respective local tracklets. Each local tracklet corresponds to a respective object (such as an observed vehicle), and has a local ID that is assigned by the respective connected vehicle 320. The local tracklets are sent from the connected vehicles 320 to the edge/cloud server 310.

The global tracklet system 305 of the edge/cloud server 310 creates global IDs for each global tracklet. In example embodiments, the format or structure of a global tracklet, or the information contained therein, is similar or analogous to that of a local tracklet, with a fixed global ID corresponding to each global object/vehicle. Each global tracklet corresponds to a specific time period or time window that the sensor data was obtained in. Each global tracklet can associate to multiple local tracklets. Both local and global tracklets have a list of features including lane information, vehicle type, size, etc. The edge/cloud server 310 receives local tracklets that identify objects and their positions/locations with local IDs. The global tracking system 305 searches for duplications, i.e., two local tracklets identifying the same object/vehicle. The global tracking system 305 associates each received local tracklet with a global tracklet to thereby assign a global ID to each object to make the object unique.

FIG. 4 is a schematic diagram illustrating a method 400 performed by a global tracklet system according to an example embodiment. The processes or operations of method 400 may be performed, e.g., by global tracklet system 305 which is part of or otherwise communicates with edge/cloud server 310. It is noted that the steps of the example method 400 shown in FIG. 4 are not necessarily performed in the order shown in FIG. 4.

Because the local tracklets received from the connected vehicles 320 are not at the same time, at operation 402 the received local tracklets are synchronized by time such that each local tracklet is associated with a specific time period; i.e., each local tracklet is associated with a time period that the sensor data comprising the local tracklet was obtained or sensed in. Each local tracklet has a timestamp which comes from the GPS time, for example. The tracklet association (the processes in the cloud server 310) happens periodically at the cloud server 310. The cloud server 310 uses the timestamp of the local tracklets of that period to estimate the respective locations of the local tracklets at the cloud server time and then associates the respective local tracklets with that new estimated location, speed, yaw, etc. The local tracklets can be stored in the database 315.

The next part of the method 400 is to attempt to associate or “match” received local tracklets with a corresponding global tracklet created by the global tracklet system 305. This can be done in various ways.

At operation 404 the global tracklet system 305 attempts to associate a respective local tracklet with a corresponding global tracklet that is already in existence, using ID matching. At operation 404 the global tracklet system 305 associates a respective local tracklet with a corresponding existing global tracklet when there is a match between the local ID of the respective local tracklet and a global ID of the corresponding existing global tracklet. If there is an existing global ID of an existing global tracklet, then the edge/cloud server 310 already saw the object identified by the existing global ID and so another received local tracklet can be associated with the existing global tracklet.

A “match” in this context, or a local tracklet being “associated” with a global tracklet, does not necessarily mean a precise match of the local ID and the global ID. This step can be performed for example by checking the local ID against a table of global IDs, each global ID in the table corresponding to a respective global tracklet. The table associates local IDs with global IDs and therefore local tracklets with global tracklets.

As merely one example, not meant to be limiting, a connected vehicle or observer vehicle 320 or ego vehicle 330 applies an algorithm (similar to the well-known SORT algorithm) that tracks multiple observed objects and assigns a Unique ID for each unique object. To make the ID unique the vehicle may use the connected/ego vehicle ID (similar to a VIN or Vehicle Identification Number) plus an item ID such as 1, 2, 3, 4+the version ID (such as V1, V2, V3)). The local ID may look like, for example, vid002-3-2. Once the global tracklet system 305 of the edge/cloud server 310 gets that local ID the first time, the global tracklet system 305 creates a UUID (Universally Unique Identified) using a known algorithm. Such known algorithms usually use a timestamp and a hash that looks like a hash value. In an example embodiment the global tracklet system 305 creates two dictionaries to associate with them: 1. {global_ID: list(local_IDs)}. 2. {local_ID: global_ID}. Thus the global tracklet system 305 can easily fetch the local IDs associated with a respective global ID and a global ID associated with a respective local ID in time complexity O(1).

As noted above, two different local tracklets may correspond to the same detected object, i.e., the same vehicle. For example two connected vehicles 320 may detect the same object/vehicle and then would assign different local IDs to the detected object/vehicle. The global tracking system 305 can scan the local IDs from the local tracklets and determine whether there are duplications, i.e., whether the same object/vehicle has been assigned different local IDs. The global tracking system 305 can then assign a unique ID to each object/vehicle by associating multiple local tracklets corresponding to the same object/vehicle with the same global tracklet. Every local ID (no matter whether there are duplications or not) is assigned a global ID. Even when duplicates occur, the duplicated local ID will be appended to the list of the matched entry of the first dictionary described above.

If at operation 404 the global tracklet system 305 is unable to match a received local tracklet with an existing global tracklet via ID matching, then the global tracklet system 305 can attempt to associate the unmatched local tracklet with an existing global tracklet in another way such as in operation 408. Accordingly, at operation 406 local tracklets that were not matched at operation 404 are sent to be processed as in operation 408. At this stage unmatched local tracklet is a local tracklet having a fixed local ID that could not be associated to or matched with a global ID of a global tracklet.

At operations 408-410 the global tracklet system 305 attempts to associate an unmatched local tracklet with an existing global tracklet by matching one or more of a position/direction/acceleration/velocity/speed/turning rate/location of an object identified by the respective local tracklet with one or more of a position/direction/acceleration/velocity/speed/turning rate/location of an object identified by an existing global tracklet. For example, at operation 408 the position/direction of an object identified by the respective local tracklet, and the position/direction of an object identified by a corresponding existing global tracklet, can be determined or calculated based on Intersection Over Union (IOU) values of each pair of unassociated local and global tracklets and their Mahalanobis distance. Thus, at operation 408 a cost matrix is generated based on the IOU values of each pair of unmatched local-global tracklets and their Mahalanobis distance.

IOU and Mahalanobis distance are known techniques. IOU is used in applications related to object detection, and is a term used to describe the extent of overlap of two polygons. The greater the region of overlap, the greater the IOU. It is noted that the present disclosure is not limited to using IOU for object detection, and other object detection techniques can be used with the disclosed technology.

Mahalanobis distance is a technique used to compute the multiple dimension distance between multiple dimension objects. A local tracklet has information including location and speed, etc. Mahalanobis distance is a measure of the distance between a point P and a distribution D. It is a multi-dimensional generalization of the idea of measuring how many standard deviations away P is from the mean of D. This distance is zero for P at the mean of D and grows as P moves away from the mean along each principal component axis. If each of these axes is re-scaled to have unit variance, then the Mahalanobis distance corresponds to standard Euclidian distance in the transformed space. The Mahalanobis distance is thus unitless, scale-invariant, and takes into account the correlations of the data set. Example embodiments can use Mahalanobis distance, but the present disclosure is not limited to using these techniques, and other distance measures can be used, including but not limited to Euclidian distance.

As an example, as noted above two different local tracklets may correspond to the same detected object, i.e., the same vehicle. However, the two local tracklets typically will not align exactly, because the time frames comprising each local tracklet are extremely small; as just one example the same object sensed by two different connected vehicles 320 may have their information misaligned by 10 ms. IOU is a measure of how much these two objects intersect, i.e., how much their positions intersect. An intersection is taken of the two objects divided by the union of the two objects. The IOU metric calculates how much a pair of data (i.e., the two detected objects) intersect. The further away the two objects are, the lower their IOU value is; the closer the two objects are to each other, the higher their IOU value is. If the IOU value is 100% then the positions of the two objects intersect. However, it is possible that two objects are close to each other but their direction is different, i.e., they are going in different directions, and therefore they are not the same object. Thus direction/acceleration/speed/turning rate/etc. are considered. If the Mahalanobis distance is large then the cost isn't reduced and it can be concluded that the vehicles are not actually close. It is noted that a tracklet (whether a local tracklet or a global tracklet) has information including velocity and direction; a tracklet is not merely a point, but, rather, tracks an object's trajectory. Location and speed are components of the trajectory formulating a vector. The distance between the location of an object and its speed as a vector is computed, to compare the distance of the observed vehicle to the tracklet. Irrelevant data can be factored out, for example, an object that is traveling in the opposite direction of the particular tracklet. Therefore, location may intersect to a degree and yet the data may be irrelevant.

Accordingly, IOU and Mahalanobis distance can determine that the two detected objects are actually of the same object. Based on the IOU value and the Mahalanobis distance, the local tracklet can be matched to an existing global ID and therefore to an existing global tracklet; alternatively, it can be determined that there is no match to a global ID and therefore this is the first time the edge/cloud server is seeing the object identified by the local tracklet. In this case a new global ID is created and a new global tracklet having the new global ID, and the local tracklet at issue can be associated with the new global tracklet.

As another example, if there are 20 detected objects, the global tracking system 305 can use IOU along with Mahalanobis distance to determine that there are only, e.g., 12 different objects out of the 20. The global tracking system 305 can then associate the 20 local tracklets with 12 respective global tracklets.

Operation 410 attempts to associate unmatched local tracklets with corresponding existing global tracklets using another method, for example a Linear Assignment Problem (LAP) solver. A Linear Assignment Problem (LAP) Solver is known in the art and is used at operation 410 to determine whether there is a match between an unmatched local tracklet and an existing global tracklet based on the IOU and Mahalanobis distance calculations performed at operation 408. A “match” in this context, or a local tracklet being “associated” with a global tracklet through position/direction as described above, does not necessarily mean a precise match. Operation 410 can be performed for example by checking the position/distance of an object identified by a local tracklet against a table of global tracklets that are listed by position/distance of objects that are identified by the respective global tracklets. Of course, the present disclosure is not limited to using a LAP Solver, and other methods of associating unmatched local tracklets with existing global tracklets based on position/direction can be used. The present disclosure is also not limited to position/distance and one or more of position/distance/acceleration/velocity/speed/turning rate/location may be used.

As noted above with respect to operation 410, a “match” in this context, or a local tracklet being “associated” with a global tracklet through position/direction as described above, does not necessarily mean a precise match. In one example this means to find associated tracklets that minimize the global distance (not limited to Euclidean/Mahalanobis distance). In one example, to solve the problem is to find the global minimal cost for a cost matrix which the system has created using the Mahalanobis distance of all possible matching pairs. An example is as follows: L-1, L-2 are two local tracklets, and G-1, G-2 are two global tracklets. Their distance is: L-1: G-1 (4), L-1: G-2 (5), L-2: G-1 (1), L-2: G-2 (3). The match L-1->G-2 and L-2->G-1 gives the minimal distance 4+1=5. Thus it can be said that local tracklet 1 matches global tracklet 2 and local tracklet 2 matches global tracklet 1. An optimal algorithm solving this problem has a time complexity O(N\hat{ }3) where N is the number of tracklets. One well known algorithm solving this problem is the Hungarian algorithm.

At operation 412, if a local tracklet was not matched with a corresponding existing global tracklet either at operation 404 or at operations 408/410, a new global tracklet is created, and the local tracklet is associated with the new global tracklet.

Referring back to operation 404, while local tracklets unmatched at operation 404 proceed through operations 406, 408, 410, and 412 as described above, local tracklets that were matched at operation 404 proceed through operation 414. At operation 416 the results are merged such that all local tracklets are associated (such as in a table or a database) with an existing global tracklet or with a new global tracklet, as discussed above, to create local-global pairs.

At operation 418 a priority score is assigned to each local tracklet based on the reliability of the particular sensor data used to create the local tracklet, e.g., based on (1) the accuracy of the one or more sensors that detected the respective object (which could be based on sensor type) and/or (2) the distance from the sensor to the observed/respective object).

At operation 420 each respective global tracklet is updated with (1) all received local tracklets associated with the respective global tracklet within the same time period and (2) the priority score assigned to each local tracklet. Thus each global tracklet is updated with the respective location and priority score of each associated local tracklet. A global map of the global tracklets may be updated as well.

In each time step, many local tracklets can be mapped to one global tracklet. One efficient updating strategy is to only update the global tracklets once each time step no matter how many local tracklets are mapped to them. One example embodiment uses a threshold of Mahalanobis distance between a pair of global and local tracklets to disregard a “bad” or erroneous observation caused by false mapping or data degradation.

In the stage of updating the global tracklets' new location, prioritization scores of local tracklets are considered. A weighted average location of the group of prioritized local tracklets can be used as the final updating parameters. In examples of the present disclosure, a priority score is treated as the weight value that is used to calculate the weighted average location of the group of prioritized local tracklets. For example, say there are two vehicles A and B say one vehicle is at location 0 and the other is at location 10. If A and B have the same priority score, then the location of the global tracklet which combines the information of these two local observations will have a weighted average location at “5”. However, If A has a higher priority, say five times that of B, then the weighted average location will be closer to A, e.g., 2 in this case.

Accordingly, in example embodiments the system calculates a weighted average location of the local tracklets associated to a global tracklet, based on the priority score assigned to each associated local tracklet.

At operation 422 gobal tracklet candidates are reduced using the cosine distance of their history trajectory. In example embodiments the priority score is used to update the new location for the global tracklets. However, redundant global tracklets can be generated by mistakenly not associating some local tracklets which should associate to that global tracklet, and these local tracklets may be falsely considered as new global tracklets. The cosine distance considers both the Euclidean distance, moving direction, and speed. Operation 422 compares nearby global tracklets' history location, moving direction, and speed (cosine distance). If two global tracklets' cosine distance is smaller than a predefined threshold, then these two global tracklets will be considered to be the same one and will be merged. It is of course to be understood that while cosine distance is one technique, other applicable techniques can be used also.

At operation 424 a global traffic map at a lane level is constructed from the updated global tracklets, to provide a global view of the traffic. The respective global tracklets or global traffic map can be used in a variety of applications. Some example embodiments utilize the respective global tracklets to create and transmit from the edge/cloud server 310 to a connected vehicle 320 a global traffic map that includes lane-by-lane traffic information.

For example a global traffic map may have lane-level coloring or other lane-level markings. A composite picture or dynamic image of the roads and lanes can be made even if only some of the vehicles on the road are connected vehicles 320 that send local tracklets to the edge/cloud server 310. The edge/cloud server 310 can use the global tracklets associated with the local tracklets along with priority to obtain the composite picture or dynamic image of the road at a lane level. The edge/cloud server 310 in one example only outputs the history of all of the global tracklets.

Some example embodiments utilize the respective global tracklets to create and send a control signal to a connected autonomous vehicle 320 based on the global traffic map in order to control a route of the autonomous connected vehicle 320 at lane level. The edge/cloud server 310 can therefore provide control signals or instructions to autonomous connected vehicles 320, or recommendations/suggestions to human drivers in other connected vehicles 320, that factor in lane-level traffic information. The edge/cloud server 310 may transmit a signal to a connected vehicle 320 to update an online navigation system of the connected vehicle 320 based on the global traffic map. For example the global traffic map can identify whether the carpool lane is free. Of course, these are just example embodiments and the present disclosure is not limited thereto.

Database 315 may store data or information including the local tracklets, the sensor data, and other data received from the connected vehicles 320. The database 315 can also store the global tracklets including their associated local tracklets, the tables referred to above for operations 404 and 410, calculations such as IOU/Mahalanobis distance, the global traffic map, etc. A history of each global tracklet may also be stored in database 315, and the global tracklet system 305 may construct a trajectory of each global tracklet based on the history. As the process at the cloud server 310 happens periodically, the global tracklets are updated periodically. As each global tracklet is treated as an object or vehicle in the digital world, their location and speed can be had in each time period. This can serve as the trajectory. As one example, sometimes the global tracklet system 305 might falsely generate multiple global tracklets for a vehicle and keep them for some time period. The global tracklet system 305 can compare their respective history trajectories to eliminate the duplicated global tracklets, as two different vehicles will not always be in the same trajectory with identical or similar speed.

Accordingly the global tracking system 305 prioritizes the detection results based on the capabilities of the source vehicles 320, and combines or aggregates the data to create a single lane-level traffic view. A traffic view showing respective single lanes of the road and the level of traffic in respective single lanes can be transmitted to a connected vehicle to be displayed by an onboard GPS or navigation system. This information can also be provided to the autonomous or self-driving vehicle systems, for example in the form of one or more control signals, to instruct or direct the autonomous vehicle to navigate the roads on a per-lane basis.

In another example embodiment, global tracklets are sent from the edge/cloud server 310 to a connected vehicle 320, and a global traffic map may also be created by the onboard navigation system of the connected vehicle 320 using the global tracklets.

Server 310 may include, for example, a microcomputer that includes a one or more processing units (e.g., microprocessors), memory storage (e.g., RAM, ROM, etc.), and I/O devices. As noted above the server 310 may store information and data related to multi-object tracking in cloud-based database 315, which may be resident on network 290. The database 315 may include one or more various forms of memory or data storage (e.g., flash, RAM, etc.) that may be used to store suitable information. The processing units of cloud server 310 execute instructions stored in memory to execute and control functions of multi-object tracking with data source prioritization.

Communication circuit 301 includes either or both of a wireless transceiver circuit 302 with an associated antenna 314 and a wired I/O interface with an associated hardwired data port (not illustrated). Communication circuit 201 can provide for V2X communication capabilities, server 310 to communicate with connected devices, such as RSE, edge devices, and/or vehicles via network 290.

Ego vehicles 330 and connected vehicles 320 may each provide similar functionality, and as such ego vehicle may be considered a connected vehicle but for explanation purposes is referred to as the “ego vehicle.” Ego vehicles 330 and connected vehicles 320 may be any type of vehicle, for example, but not limited to, a car; a truck; a sports utility vehicle; a bus; a semi-truck; a drone or any other roadway-based conveyance. Ego vehicles 330 and/or connected vehicles 320 may be implemented as vehicle 100 of FIG. 1. As such, ego vehicle 330 can comprises vehicle systems 332 and vehicle sensors 334 that are substantially similar to vehicle systems 258 and sensors 252 of FIG. 2. Ego vehicle 330 also includes multi-object tracking circuit 336, which may be substantially similar to multi-object tracking circuit 210 of FIG. 2. Similarly, connected vehicle 320 comprises vehicle systems 322 and vehicle sensors 324 that are substantially similar to vehicle systems 258 and sensors 252 of FIG. 2, along with multi-object tracking circuit 326 that is substantially similar to multi-object tracking circuit 210 of FIG. 2.

Ego vehicle 330 (and/or connected vehicle 320) may have V2X communication capabilities, allowing vehicles to communicate with edge devices, roadside infrastructure (e.g., such as RSE 340, which may be a vehicle-to-infrastructure (V2I)-enabled street light and/or cameras, for example). Vehicle 330 (or vehicles 320) may also communicate with other vehicles 320 over vehicle-to-vehicle (V2V) communications. It should be understood that sometimes, a vehicle itself may act as a network node, edge computing device, or a combination thereof. For example, vehicle 330 may operate as a network edge device. The data gathered by vehicles 330 (or vehicles 320), either through their own sensors, and/or other data sources, e.g., RSE 340 and other vehicles, may be ultimately be transmitted to the server 310. Furthermore, in some embodiments, a vehicle itself may act as a edge server.

The RSE 340 includes systems 342 and sensors 344. The RSE 340 can be implemented, for example, as a computing component. The sensors 344 may be similar to sensors 252, for example, comprising environmental sensors 228 (e.g., to detect salinity and/or other environmental conditions), proximity sensors 230 (e.g., sonar, radar, lidar and/or other vehicle proximity sensors), and image sensors 260 the like for capturing data of an environment surrounding the RSE 340. The sensors can also detect information such as a location, velocity, yaw, yaw rate, and acceleration of another object or vehicle.

Systems 342 may include, for example, object detection system 278 to perform image processing such as object recognition and detection on images from image sensors 260, proximity estimation, for example, from image sensors 260 and/or proximity sensors, etc. The RSE 340 may also have known geographic coordinates and/or comprises a GPS unit of its own. In various embodiments, the multi-object tracking system 200 of FIG. 2 and/or the server 310 of FIG. 3 receive data from sensors 344. The data can be stored in database 209 and/or database 315 and used by the multi-object tracking client 205 or the global tracklet system 305.

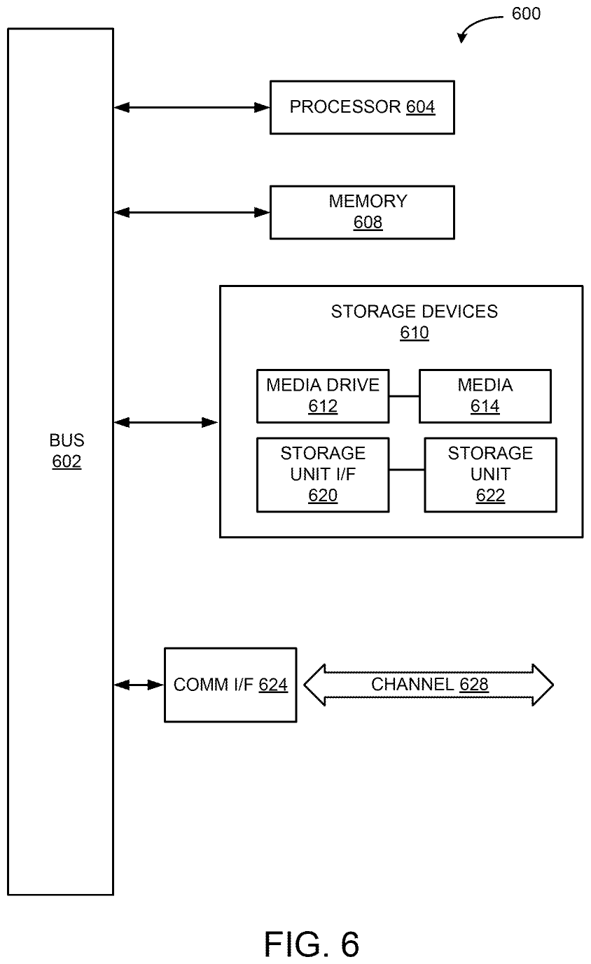

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up range estimation system 200 of FIG. 2 and/or server 310 of FIG. 3. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 1508. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 150 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method implemented in a cloud server for tracking multiple objects detected by vehicles, the method comprising:
receiving a plurality of local tracklets, each local tracklet received from a respective vehicle, each local tracklet comprising sensor data corresponding to a respective object detected at lane level within a respective time period;
associating a respective local tracklet with a corresponding existing global tracklet when there is a match between the respective local tracklet and a corresponding existing global tracklet;
assigning a priority score to each received local tracklet;
updating each respective global tracklet with (1) all received local tracklets associated with the respective global tracklet within a same time period, (2) the priority score assigned to each associated local tracklet, and (3) a weighted average location of the associated local tracklets based on the priority score assigned to each associated local tracklet;
removing redundant global tracklets; and
constructing a global traffic map at lane level from the updated global tracklets.

2. The method of claim 1, wherein each local tracklet has a local ID assigned by the respective vehicle, and a respective local tracklet is associated with a corresponding existing global tracklet when there is a match between (1) the local ID of the respective local tracklet and a global ID of the corresponding existing global tracklet, or (2) a position/direction of an object identified by the respective local tracklet and a position/direction of an object identified by the corresponding existing global tracklet.

3. The method claim 1, further comprising transmitting the global tracklet map to one or more vehicles.

4. The method of claim 1, further comprising transmitting a control signal to an autonomous vehicle based on the global traffic map to control a route of the autonomous vehicle at lane level.

5. The method of claim 1, further comprising transmitting a signal to a connected vehicle to update an online navigation system of the vehicle based on the global traffic map.

6. The method of claim 1, wherein each local tracklet includes identifying data comprising location, velocity, yaw, yaw rate, and acceleration of the respective object.

7. The method of claim 1, wherein each object corresponds to an observed vehicle.

8. The method of claim 1, further comprising storing each received local tracklet in a non-linear filter.

9. The method of claim 1, further comprising storing a history of each global tracklet, and constructing a trajectory of each global tracklet based on the history.

10. The method of claim 2, further comprising determining the position/direction of an object identified by the respective local tracklet and the position/direction of an object identified by a corresponding existing global tracklet based on Intersection Over Union (IOU) values of each pair of unassociated local and global tracklets and their Mahalanobis distance, and using a Linear Assignment Problem (LAP) Solver to determine the match.

11. The method of claim 1, further comprising calculating a weighted average of the priority scores of the plurality of local tracklets that are from within the same time period.

12. The method of claim 1, further comprising associating a respective local tracklet with a corresponding new global tracklet when there is no match.

13. The method of claim 1, wherein the priority score is assigned to each received local tracklet based on at least one of (1) an accuracy of one or more sensors that detected the respective object or (2) a distance from the one or more sensors to the respective object.

14. A system implemented in an edge/cloud server for tracking multiple objects detected by vehicles, the system comprising:
a memory storing instructions; and
one or more processors communicably coupled to the memory and configured to execute the instructions to:
receive a plurality of local tracklets, each local tracklet received from a respective vehicle, each local tracklet comprising sensor data corresponding to a respective object detected at lane level within a respective time period using one or more sensors communicating with the respective vehicle;
associate a respective local tracklet with a corresponding existing global tracklet when there is a match between the respective local tracklet and a corresponding existing global tracklet;
assign a priority score to each received local tracklet;
update each respective global tracklet with (1) all received local tracklets associated with the respective global tracklet within a same time period, (2) the priority score assigned to each associated local tracklet, and (3) a weighted average location of the associated local tracklets based on the priority score assigned to each associated local tracklet;
removing redundant global tracklets; and
constructing a global traffic map at lane level from the updated global tracklets.

15. The system of claim 14, wherein each local tracklet has a local ID assigned by the respective connected vehicle, and a respective local tracklet is associated with a corresponding existing global tracklet when there is a match between (1) the local ID of the respective local tracklet and a global ID of the corresponding existing global tracklet, or (2) a position/direction of an object identified by the respective local tracklet and a position/direction of an object identified by the corresponding existing global tracklet.

16. The system of claim 14, wherein a respective local tracklet is associated with a corresponding new global tracklet when there is no match.

17. The system of claim 14, wherein a priority score is assigned to each received local tracklet based on at least one of (1) an accuracy of the one or more sensors that detected the respective object or (2) a distance from the one or more sensors to the respective object.

18. A vehicle, comprising:
a memory storing instructions; and
one or more processors communicably coupled to the memory and configured to execute the instructions to:
detect an object within a respective time period using one or more sensors, at least one sensor configured to detect lane-level traffic data;
create a local tracklet comprising sensor data corresponding to the detected object;
assign a local ID to the local tracklet;
transmit the local tracklet to an edge/cloud server; and
receive a global traffic map from the edge/cloud server, the global traffic map constructed from a plurality of global tracklets, each global tracklet comprising associated local tracklets received from respective vehicles, each associated local tracklet corresponding to a same object detected at a same time period, wherein
a respective local tracklet was associated with a corresponding existing global tracklet when there was a match between (1) the local ID of the respective local tracklet and a global ID of the corresponding existing global tracklet, or (2) a position/direction of an object identified by the respective local tracklet and a position/direction of an object identified by the corresponding existing global tracklet,
the respective local tracklet was associated with a corresponding new global tracklet when there was no match,
a priority score was assigned to each local tracklet based on (1) an accuracy of the one or more sensors that detected the respective object and (2) a distance from the one or more sensors to the respective object,
each respective global tracklet was updated with (1) all local tracklets associated with the respective global tracklet within the same time period, (2) the priority score assigned to each associated local tracklet, and (3) a weighted average location of the associated local tracklets based on the priority score assigned to each associated local tracklet, and redundant global tracklets were removed, and
the global traffic map was constructed at lane level from the updated global tracklets.

19. The connected vehicle of claim 18, wherein the connected vehicle is an autonomous vehicle and the one or more processors execute further instructions to:
receive a control signal based on the global traffic map, to control a route of the connected vehicle at a lane level.

20. The connected vehicle of claim 18, wherein the one or more processors execute further instructions to:
receive a signal to update an online navigation system of the connected vehicle based on the global traffic map.
